(19) United States
(12) Patent Application Publication
(10) Pub. No.: US 2025/0377895 A1
(43) Pub. Date: Dec. 11, 2025

(54) FETCH BLOCK-BASED BRANCH PREDICTION

(71) Applicant: Synopsys, Inc., Sunnyvale, CA (US)

(72) Inventors: Chi-Chang Lai, Hsinchu (TW); Chun-Ying Huang, Hsinchu (TW); Ya-Yun Hou, Hsinchu (TW); Wu-Hsien Chuang, Hsinchu (TW)

(21) Appl. No.: 19/233,906

(22) Filed: Jun. 10, 2025

Related U.S. Application Data
(60) Provisional application No. 63/658,392, filed on Jun. 10, 2024.

(51) Int. Cl. G06F 9/38

(52) U.S. Cl. CPC G06F 9/3804; G06F 9/3848; G06F 9/3867

(57) ABSTRACT

A computer-implemented method of predicting a branch direction of a fetch block in a processor, includes in part, determining a multitude of first counts each associated with a different one of a multitude of branch offsets of a branch direction predictor data associated with the fetch block. Each of the multitude of first counts represents the number of times that the associated branch offset was taken during a multitude of fetch cycles. The computer-implemented method further includes, in part, determining a second count associated with the fetch block. The second count represents the number of times that none of the multitude of branch offsets were taken during the multitude of fetch cycles. The computer-implemented method further includes, in part, computing a confidence level based on the multitude of first counts and the second count, and determining the branch direction of the fetch block in accordance with the computed confidence level.

### RELATED APPLICATION

The present application claims benefit under 35 U.S.C. § 119 to U.S. Provisional Application No. 63/658,392, filed on Jun. 10, 2024, the content of which is incorporated herein by reference in its entirety.

### TECHNICAL FIELD

The present application relates to a processor circuit, and more particularly to a block-based prediction of one or more instruction branches.

### BACKGROUND

A branch prediction function unit may be used in a processor (e.g., a microprocessor) to predict the direction of an instruction branch before the direction is definitively established. A branch in a processor refers to an instruction sequence. A branch prediction function unit improves the parallelism of the instruction pipeline and is thus a key component of a high performance pipelined microprocessor.

A predicted branch may be indicated as either taken or not taken. When taken, the predicted branch causes another address in the instruction memory to be pointed to. If not taken, the next immediate instruction is used. At the time of the prediction, it is not known with certainty whether a branch to another instruction will be taken or not taken until the condition used in making the prediction is later calculated during the execution stage in the instruction pipeline.

### BRIEF DESCRIPTION OF THE DRAWINGS

The disclosure will be understood more fully from the detailed description given below and from the accompanying figures of embodiments of the disclosure. The figures are used to provide knowledge and understanding of embodiments of the disclosure and do not limit the scope of the disclosure to these specific embodiments. Furthermore, the figures are not necessarily drawn to scale.

FIG. 1 shows the content of a branch direction predictor data associated with a fetch block, in accordance with one embodiment of the present disclosure.

FIG. 2 shows the content of another branch direction predictor data associated with a fetch block, in accordance with another embodiment of the present disclosure.

FIG. 3 shows the content of a target address predictor data associated with a fetch block, in accordance with one embodiment of the present disclosure.

FIG. 4 shows the content of another target address predictor data associated with a fetch block, in accordance with another embodiment of the present disclosure.

FIG. 5 shows the content of a filter generator and slots selection table for update, in accordance with one embodiment of the present disclosure.

FIG. 6 shows a flowchart for determining a predicted direction and a target address associated with a fetch block, in accordance with one embodiment of the present disclosure.

FIG. 7 shows another flowchart for determining a predicted direction and a target address associated with a fetch block, in accordance with another embodiment of the present disclosure.

FIG. 8 shows a flowchart for determining a predicted direction associated with a fetch block, in accordance with one embodiment of the present disclosure.

FIG. 9 is a schematic diagram of an example computer system in which embodiments of the present disclosure may operate.

### DETAILED DESCRIPTION

Aspects of the present disclosure relate to fetch block-based branch prediction in a multi-instruction pipelined processor performing speculative execution.

A “taken branch” refers to a branch instruction in a program that takes the program execution flow to a specific target address determined by the branch instruction.

A “taken branch offset” refers to a relative location of a taken branch in respect to the fetch block the branch instruction resides.

A “predicted target address” refers to the output of a branch target prediction structure representing a best guess in determining the target address by the taken branch associated with the predicted direction.

A “prediction history” refers to partial or the entirety of information recorded about the historical predicted directions and predicted target addresses; the longer the history the more accurate the prediction result.

A “predictor table” refers to a table storing branch direction prediction structure data and tags.

In a pipelined processor implementing multi-instruction branch prediction, a branch prediction logic unit is replicated to include a branch predictor for prediction of each of a multitude of instructions, thereby resulting in significant hardware usage and cost. Such a processor including multi-instruction branch prediction logic therefore lacks scalability and is highly expensive.

A branch prediction logic unit disposed in a pipelined processor, in accordance with one aspect of the present disclosure, generates a predicted target address associated with fetching of multiple instructions, referred to herein as a fetch block, in one operating clock cycle. The target address of the fetch block is subsequently fed back to the branch prediction unit for predicting the address of the next target block. Among technical advantages of the present disclosure is a pipelined processor with a multi-instruction branch prediction logic that is scalable, relatively small, has higher operating efficiency, and less costly to manufacture.

The target address of a fetch block is split into a fetch block base address, defining the address pointing to the beginning of the fetch block, and a fetch target offset as the difference between the fetch target address and the fetch block base address. The addresses in a fetch block are contiguous. For example, if a fetch block contains three instructions and the starting base address of the fetch block is 1000, then the offset addresses of the first instruction, the second instruction and the third instructions are respectively 0, 1, and 2.

The fetch block base address is combined with a prediction history data to generate an index that is subsequently used to look up one or more predictor tables to identify a branch direction predictor data, alternatively referred to herein as B_DIR_s, using any one of a number of techniques. For example, a 32-bit processor implementing a 32-bit fetch address and having a predictor table with 1024 entries, requires a 10-bit index to uniquely identify an entry in one or more direction predictor tables (not shown). The index to the one or more predictor table may be defined by combining, for example, a few hundred bits of historical predicted directions, as stored in a history table (not shown), with the current fetch block base address. In one example, a hashing function may be used to hash the bits corresponding to the historical predicted directions with the current fetch block base address to generate, for example, a 10-bit index pointing to an entry in the predictor table(s) identifying B_DIR_s.

As is described in detail below, B_DIR_s determines the branch direction taken at a specific offset of the fetch block base using the knowledge gained and recorded for all known branch instructions taken from the fetch block base offset, or using the known historical predicted directions taken from the fetch block base offset. If no entry is found in the predictor table, then B_DIR_s indicates that no branch is taken for the fetch block.

The fetch block base address is further used to generate another index used to look up one or more predictor tables to identify a branch target address predictor data, alternatively referred to herein as B_TGT_s, using any one of a number of techniques. The B_TGT_s determines the next fetch target address for a taken branch from a specific offset of the fetch block using predictors recorded for all known branch instructions located at the fetch target offset or within the fetch block. The determined branch taken direction for a fetch block is stored in the history table for the next lookup. Moreover, a portion of the predicted target address may also be stored in the history table for the next lookup.

The following description of the embodiments of the present disclosure are made with reference to figures in which a fetch block is shown as including two branch instructions with two different offset addresses. However, it is understood that embodiments of the present disclosure apply to a fetch block having any number of instructions with offset addresses that exceed 2, such as 3, 4, 15, 16 or more.

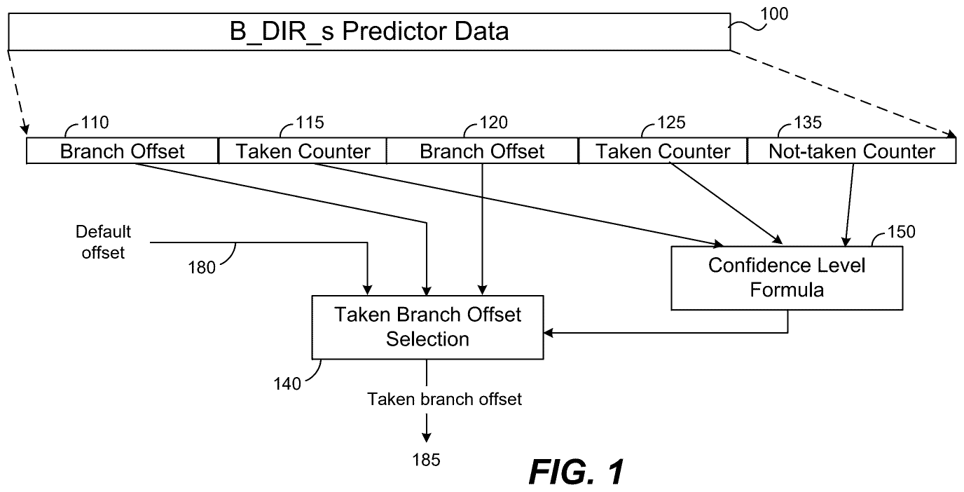

FIG. 1 shows, in part, the content of B_DIR_s predictor data 100 for an example in which the fetch block includes two different addresses, in accordance with one embodiment of the present disclosure. The direction data determined from B_DIR_s predictor data 100 indicates from which offset of the fetch block the current instruction is branched out. The first instruction is shown as having a branch offset 110, and the second instruction is shown as having branch offset 120. For example, if the base address of the fetch block is 1500, then the offset for the first branch offset 110 is 0, and the offset for the second branch offset 120 is 1.

Taken counter 115 is associated with branch offset 110 and keeps count of the number of times branch offset 110 has been taken in determining the next fetch block. For example, taken counter 115 determines a first count where branch offset 110 was taken during a number of fetch cycles (e.g., a previous number of fetch cycles). Similarly, taken counter 125 is associated with branch offset 120 and keeps count of the number of times branch offset 120 has been taken in determining the next fetch block. If the fetch block includes, for example, 16 addresses, a corresponding B_DIR_s predictor data may be implemented with fewer pairs of branch offsets and taken counters, e.g., with 4 pairs of branch offsets, in which case the B_DIR_s predictor data may hold direction prediction data for up to 4 branch instructions located at 4 different address offsets on the fetch block. In another example, a corresponding B_DIR_s predictor data may be implemented with, e.g. 16 pairs of branch offsets and taken counters only, for example, 4 of which may be valid at any given time, thus indicating that up to 4 branch instructions at 4 locations of the fetch block were detected as valid branch instructions for which the direction prediction data has been trained for. The B_DIR_s predictor data 100 is also shown as including a not-taken counter 135 that keeps a count of the number of times that none of the branch offsets in the B_DIR_s predictor data 100 were taken over a time window in determining the next fetch block. For example, not-taken counter 135 determines a second count where branch offset 120 was not taken during the number of fetch cycles (e.g., a previous number of fetch cycles).

Confidence level formula block 150 receives the values of taken counters 115, 125 and not-taken counter 135, and computes a confidence level from these values. Taken branch offset selection block 140 receives branch offset 110, branch offset 120, and default offset 180 as input. Based on the computed confidence level, confidence level formula block 150 may select either branch offset 110 or branch offset 120 (e.g., with the highest confidence level) as the branch offset 185 to be taken from branch offset selection block 140. If, however, confidence level formula block 150 does not select either branch offset 110 or branch offset 120 due to their computed confidence levels, then confidence level formula block 150 selects default offset 180 as the branch offset to be taken from branch offset selection block 140.

Determining the confidence levels using the values of taken and non-taken counters may be performed using any one of a number of techniques. For example, a 3-level confidence may be calculated according to the difference between a 2-bit taken counter value and a 2-bit not-taken counter value. More specifically, a 3-level confidence defined as high, medium, and low may be determined respectively if the difference between the taken counter and the not-taken counter is 3, 2, (1 or 0), while the counter with the larger value would influence the direction of the taken or not-taken counter.

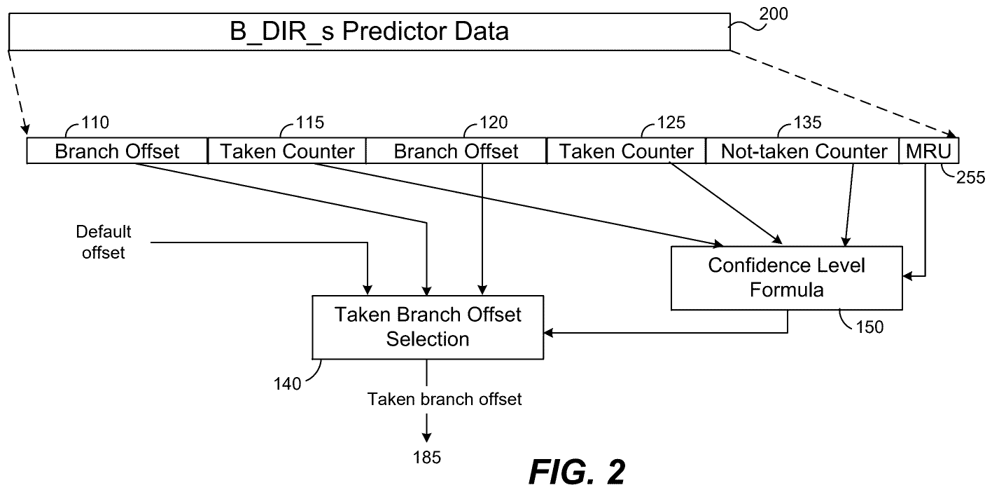

FIG. 2 shows, in part, the content of B_DIR_s predictor data 200 for an example in which the fetch block includes two different addresses, in accordance with another embodiment of the present disclosure. B_DIR_s predictor data 200 is similar to B_DIR_s predictor data 100 except that B_DIR_s predictor data 200 includes the most recently used (MRU) data 255 representing the predicted direction that was most recently used by the confidence level formula block 150. In one embodiment, MRU 255 may be provided with a higher weight in determining the predicted branch offset direction.

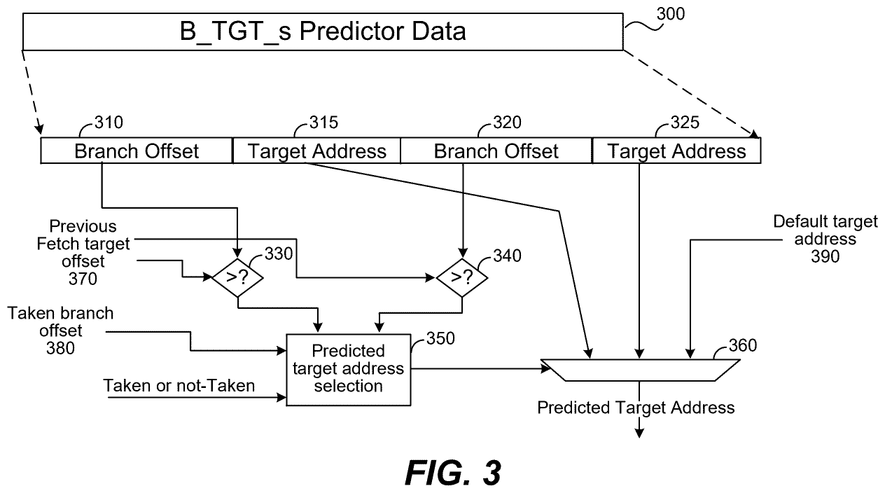

FIG. 3 shows, in part, the content of B_TGT_s predictor data 300 for an example in which the fetch block includes two different target addresses, in accordance with another embodiment of the present disclosure. The B_TGT_s predictor data 300 is used to determine the base address of the next fetch block, as described further below. The example of B_TGT_s predictor data 300 is shown as including, in part, a first branch offset 310 with an associated target address 315, and a second branch offset 320 that has an associated target address 325.

If branch offset 310 is determined to be smaller than the previous fetch target offset 370 of the fetch block, a first mask bit corresponding to branch offset 310 is set to logic 0 by comparator 330. If branch offset 310 is determined to be equal to or larger than the offset of the previous target address 370 of the fetch block, the first mask bit corresponding to branch offset 310 is set to logic 1 by comparator 330. The first mask bit is then appended to branch offset 310 and delivered to predicted target address selection block 350.

In one embodiment, a first mask bit with a logic value of 0 indicates that branch offset 310 is not to be used in determining the next target address; and a first mask bit with a logic value of 1 indicates that branch offset 310 may be used in determining the next target address. In another embodiment, a first mask bit with a logic value of 1 indicates that branch offset 310 is not to be used in determining the next target address; and a first mask bit with a logic value of 0 indicates that branch offset 310 may be used in determining the next target address.

Similarly, if the branch offset 320 is determined to be smaller than the offset of the previous target address 370 of the fetch block, a second mask bit corresponding to branch offset 340 is set to logic 0 by comparator 340. If the branch offset 320 is determined to be equal to or larger than the offset of the previous target address 370 of the fetch block, the second mask bit corresponding to branch offset 320 is set to logic 1 by comparator 340. The second mask bit is then appended to branch offset 320 and delivered to block 350. In one embodiment, a second mask bit with a logic value of 0 indicates that branch offset 320 is not to be used in determining the next target address; and a second mask bit with a logic value of 1 indicates that branch offset 320 may be used in determining the next target address. In another embodiment, a first mask bit with a logic value of 1 indicates that branch offset 370 is not to be used in determining the next target address; and a first mask bit with a logic value of 1 indicates that branch offset 370 may be used in determining the next target address.

Predicted target address selection block 350 receives the bit-mask appended branch offsets from comparators 330 and 340. Predicted target address selection block 350 also receives the taken branch offset 380 (e.g., the taken branch offset output 185 in FIG. 1 or FIG. 2)—which may be a default address if none of the branch offsets described above with reference to FIGS. 1 and 2 are taken. If the taken branch offset 380 matches the branch offset having a bit mask of 1, as determined by predicted target address selection block 350, then the target address corresponding to that branch offset is selected by multiplexer 360 as the predicted target address of the next fetch block. If no match is found between the branch offset with a mask bit of 1 and the taken branch offset 380, then the default address 390 is selected by multiplexer 360 as the predicted target address of the next fetch block.

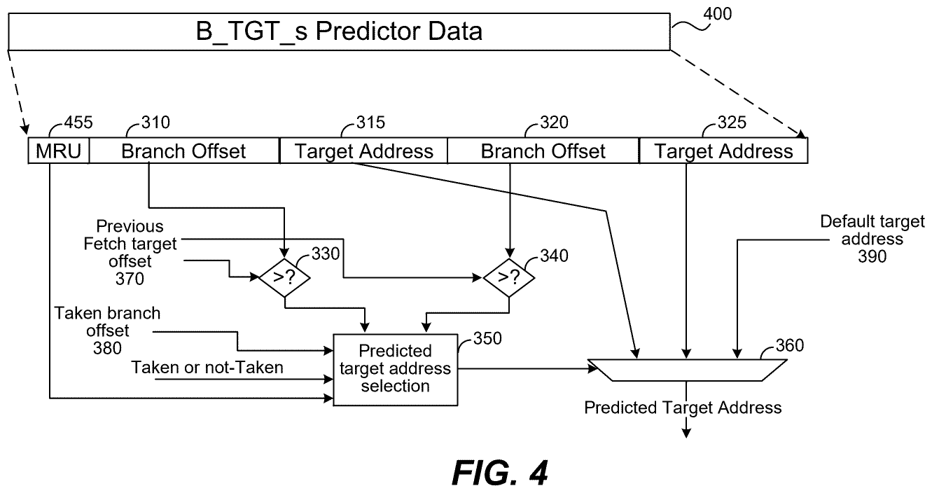

FIG. 4 shows, in part, the content of B_TGT_s predictor data 400 for an example in which the fetch block includes two different addresses, in accordance with another embodiment of the present disclosure. B_TGT_s predictor data 400 is similar to B_TGT_s predictor data 300 except that B_TGT_s predictor data 400 includes the MRU 455. MRU 455 represents the most recently used predicted target address in determining the predicted target address. In one embodiment, MRU 455 may be provided with a higher weight in determining the predicted target address of the next fetch block.

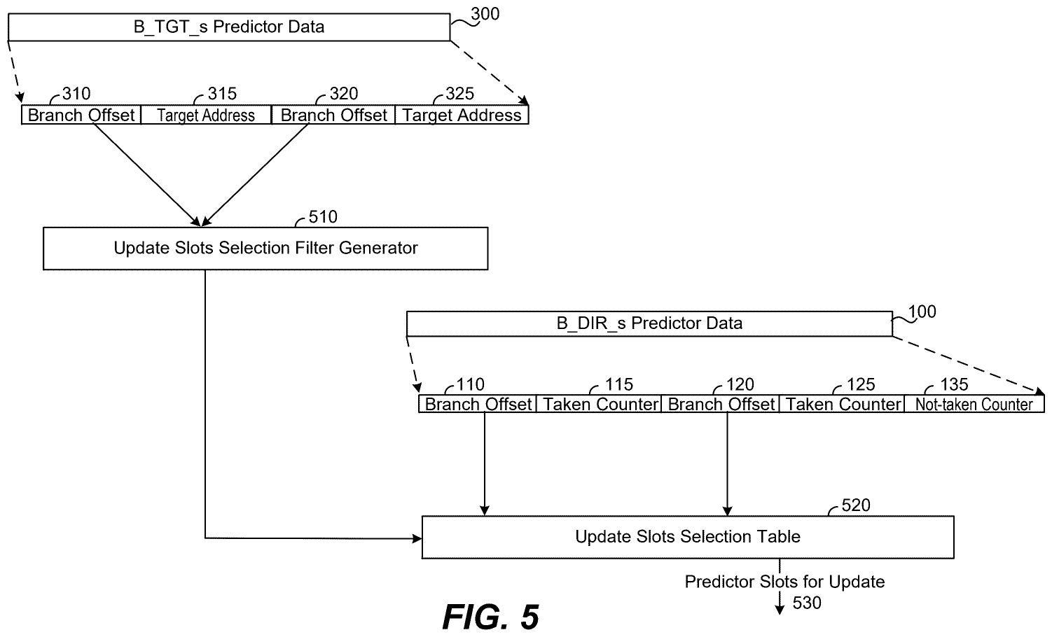

In accordance with one aspect of the present disclosure, the B_TGT_s predictor data is used to filter out the selection of the B_DIR_s predictor for update. FIG. 5 shows, in part, the B_TGT_s predictor data 300 as well as the B_DIR_s predictor data 100 that were also shown and described above with reference to FIGS. 1/2 and 3/4, respectively. Each of the branch offsets 310 and 320 of B_TGT_s predictor data 300 has an associated mask bit that is set to logic 1, by a control logic unit (not shown), in the corresponding mask bit of the update slots filter generator 510. For example, if the update slots selection filter generator 510 has a total of 16 mask bits, then the 2 mask bits corresponding to branch offsets 310 and 320 associated with B_TGT_s predictor data 300 are set to logic 1 in the 16-bit mask of update slots selection filter generator 510 by the control logic unit.

Similarly, each of the branch offsets 110 and 120 of B_DIR_s predictor data 100 has an associated mask bit that is set to logic 1, by the control logic unit in the corresponding mask bit of the update slots selection table 520. For example, if the update slot selection table 520 (alternatively referred to herein as slots selection table) has a total of 16 mask bits, then the 2 mask bits corresponding to branch offsets 110 and 120 associated with B_DIR_s predictor data 100 are set to logic 1 in the 16-bit mask of selection table 520 by the control logic unit. The 16-bit masks of the update slots selection filter generator 510 (alternatively referred to herein as filter generator) associated with B_TGT_s predictor data 300 are then used to filter the 16-bit mask of the slots selection table 520 associated with B_DIR_s predictor data 100. As a consequence, a pair of branch offset and taken counter associated with B_DIR_s predictor data 100 is selected as predictor slots for update 530 by a select logic unit (not shown) if both the associated bit of the 16-bit mask of filter generator 510 and the associated bit of the 16-bit mask of slots selection are set to logic 1.

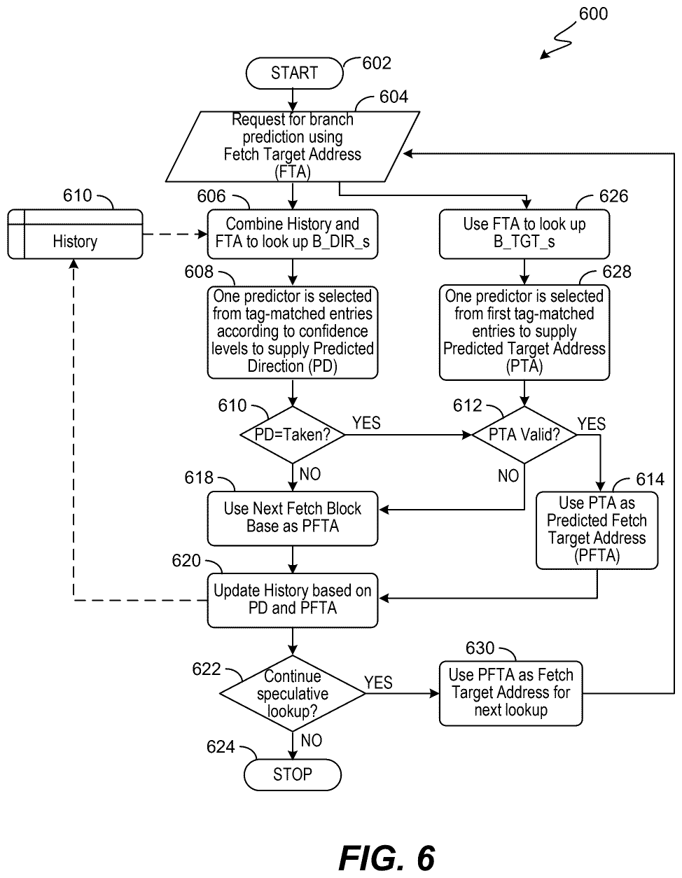

FIG. 6 is a flowchart 600 for predicting a branch direction and a target address of a fetch block, in accordance with one embodiment of the present disclosure. The flow starts at 602, subsequent to which at 604 a request for branch prediction using the previously predicted fetch target address (PFTA) at 630 as the fetch target address (FTA) is made. The fetch target address at 604, as described above, is combined with data from the history table at 610 to perform a look up at 606 in one or more associated predictor table(s) for B_DIR_s predictor data. An entry in the predictor table(s) that is tag-matched is then selected based on a confidence level as providing the predicted direction (PD) at 608.

If the PD is determined to be taken at 610 and the predicted target address (PTA) is determined to be valid at 612, then at 614 the PTA is used as the PFTA. If the PD is determined not to be taken at 610 or the PTA is determined not to be valid at 612, then the next fetch block base address is used as PFTA at 618. At 620, history table 610 is updated based on the PD and PFTA. If at 622, a decision is made not to continue with speculative lookup for fetch block-based branch prediction, the flow ends at 624. If at 622, a decision is made to continue with speculative lookup for fetch block-based branch prediction, the PFTA is used as the fetch target address for the next lookup at 630. At 626, the FTA is used to perform a lookup in one or more associated predictor tables for B_TGT_s predictor data. One entry in the predictor table(s) that is tag-matched is selected as providing the PTA at 628. If the selected PTA is determined at 612 to be valid, then the flow continues to 614. If the selected PTA is determined at 612 not to be valid, the flow continues at 618. A PTA is considered to be valid at 612 if the PTA's associated branch offset (shown at 310 and/or 320 in FIG. 3) is determined not to be smaller than the previous fetch target offset (shown at 370 in FIG. 3).

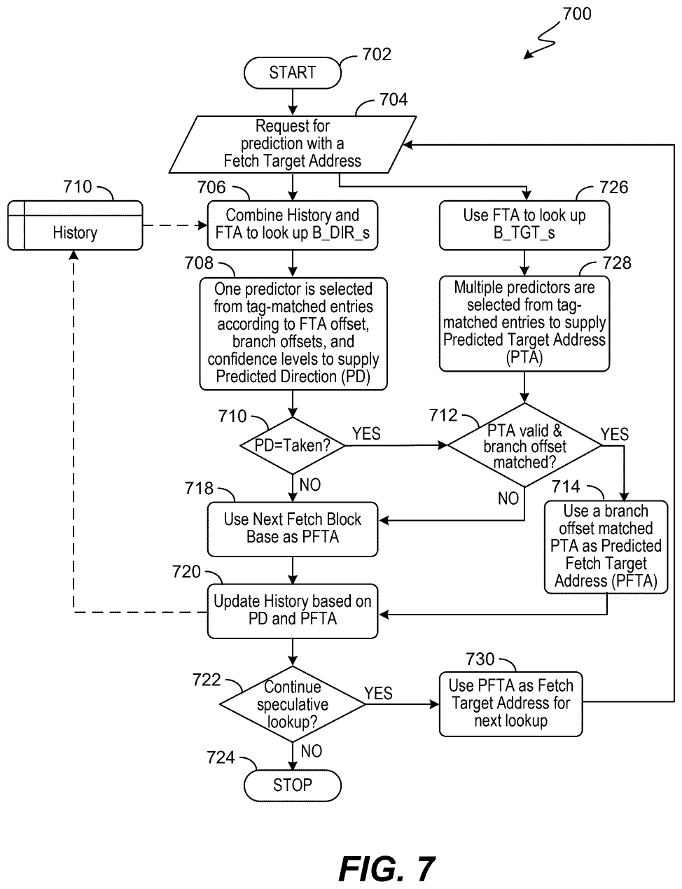

FIG. 7 is a flowchart 700 for predicting a branch direction and a target address, in accordance with another embodiment of the present disclosure. The flow starts at 702, subsequent to which at 704 a request for branch prediction using the PFTA at 730 as the fetch target address (FTA) is made. The fetch target address at 704 is combined with data from the history table at 710 to perform a lookup at 706 in one or more associated predictor table(s) for B_DIR_s predictor data. One entry in the predictor table(s) that is tag-matched is then selected based on the FTA offset, branch offset and confidence level as providing the predicted direction (PD) at 708.

If the PD is determined to be taken at 710, and at 712 the PTA is determined to be valid and the branch offset is matched, then at 714 the branch offset matching PTA is used as the PFTA. If the PD is determined not to be taken at 710, or the PTA is determined not to be valid at 712 or the branch offset is not matched, then the next fetch block base address is used as PFTA at 718. At 720, history table 710 is updated based on PD and PFTA. If at 722, a decision is made not to continue with speculative lookup for fetch block-based branch prediction, the flow ends at 724. If at 722, a decision is made to continue with speculative lookup for fetch block-based branch prediction, the PFTA is used as the fetch target address for the next lookup at 730. At 726, the FTA is used to perform a lookup in one or more associated predictor table(s) for B_TGT_s predictor data.

Multiple PTAs that are tag-matched are selected from multiple predictors at 728. The branch offsets associated with the selected PTAs that are determined to be valid are compared to the taken branch offset (shown at 380 in FIG. 3) at 712 to select one PTA, from among the multiple PTAs, for use as PFTA at 714. A PTA is considered to be valid if the PTA's associated branch offset is determined not to be smaller than the previous fetch target offset (shown at 370 in FIG. 3). If the selected PTA is determined at 712 to be valid and the branch offset is matched, then the flow continues to 714. If the selected PTA is determined at 712 not to be valid or the branch offset is not matched, the flow continues at 718.

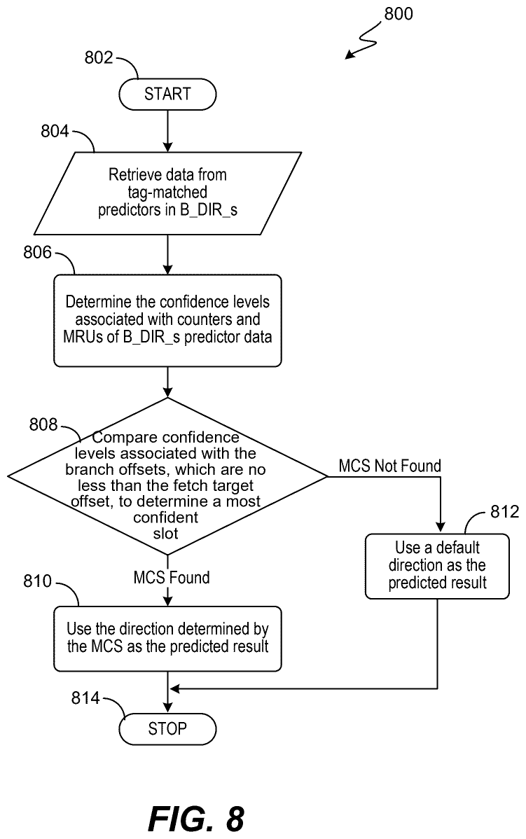

FIG. 8 is a flowchart 800 for predicting the branch direction of a fetch block, in accordance with one embodiment of the present disclosure. The branch direction prediction process starts at 802, subsequent to which at 804 multiple B_DIR_s predictor data are retrieved from tag-matched entries stored in one or more predictor table(s). At 806, the values of taken counters, non-taken counters, and MRU are extracted from the retrieved B_DIR_s predictor data and used by a confidence level generator to determine the associated confidence levels.

At 808, the branch offsets are extracted from the retrieved B_DIR_s predictor data and checked against the fetch target offset. If all extracted branch offsets are determined to be smaller than the fetch target offset, then the most confident slot (MCS) is considered as not being found, subsequent to which at 812 a default direction is used as the predicted direction. For branch offsets that are not smaller than the fetch target offset, their associated confidence levels are computed and compared against each other to identify one prediction slot in combination of a branch offset and its associated confidence level as the most confident slot, which may be the one with the highest computed confidence level. The direction determined by the MCS is used as the predicted direction at 810. The flow then ends at 814.

A computer-implemented method of predicting a branch direction of a fetch block in a processor, in accordance with one embodiment of the present disclosure includes, in part, determining a multitude of first counts each associated with a different one of a multitude of branch offsets of a branch direction predictor data associated with the fetch block. Each of the multitude of first counts represents a number of times that the associated branch offset was taken during a multitude of fetch cycles. The method further includes, in part, determining a second count associated with the fetch block, the second count representing a number of times that none of the multitude of branch offsets were taken during the multitude of fetch cycles. The method further includes, in part, computing a confidence level based on the multitude of first counts and the second count; and determining the branch direction of the fetch block in accordance with the computed confidence level.

In one embodiment, the method further includes, in part, determining the branch direction of the fetch block further in accordance with data representative of a most recently used branch direction. In one embodiment, the method further includes, in part, setting a mask bit associated with each of the multitude of branch offsets of a branch target address predictor data associated with the fetch block to a first logic level if the branch offset of the branch target address predictor data is determined to be equal to or larger than an offset of a previous target address of another fetch block; and appending the mask bit to the associated branch offset of the branch target address predictor data.

In one embodiment, the method further includes, in part, selecting, from among a multitude of target addresses each associated with a different branch offset of the branch target address predictor data and the fetch block, a target address whose associated mask bit appended branch offset matches the branch offset associated with the determined branch direction. In one embodiment, the method further includes, in part, selecting a default target address for the fetch block if no match is found between the mask bit appended branch offsets and the branch offset associated with the determined branch direction.

In one embodiment, the method further includes, in part, updating a filter generator by setting a mask bit associated with each branch offset of a branch target address predictor data corresponding to the fetch block to a first logic level. In one embodiment, the method further includes, in part, setting a mask bit associated with each branch offset of a branch target address predictor data corresponding to the fetch block to a first logic level; setting a mask bit associated with each branch offset of the branch direction predictor data corresponding to the fetch block to the first logic level; and updating a slots selection table with those mask bits of the branch offsets of the branch target address predictor data match the mask bits of the branch direction predictor data.

In one embodiment, the method further includes, in part, combining the fetch block base address with data stored in a prediction history table to generate a first index used to select the branch direction predictor data from at least a first predictor table. In one embodiment, the method further includes, in part, generating a second index from the fetch block base address to select the branch target address predictor data from at least a second predictor table. In one embodiment, the method further includes, in part, updating the prediction history table with the determined branch direction. The prediction history table can also be updated with the predicted fetch target address.

A pipelined processor, in accordance with one embodiment of the present

disclosure, includes in part, a first counter circuit to determine a multitude of first counts each associated with a different one of a multitude of branch offsets of a branch direction predictor data associated with the fetch block, each of the multitude of first counts representing a number of times that the associated branch offset has been taken during a plurality of fetch cycles. The pipelined processor further includes, in part, a second counter circuit to determine a second count associated with the fetch block, the second count representing a number of times that none of the multitude of branch offsets were taken during the multitude of fetch cycles. The pipelined processor further includes, in part, a confidence level circuit to compute a confidence level based on the multitude of first counts and the second count; and a first selection circuit to determine the branch direction of the fetch block in accordance with the computed confidence level.

In one embodiment of the pipelined processor, wherein the selection circuit further determines the branch direction of the fetch block further in accordance with data representative of a most recently used branch direction. In one embodiment, the pipelined processor further includes, in part, a comparator circuit to: set a mask bit associated with each of the multitude of branch offsets of a branch target address predictor data associated with the fetch block to a first logic level if the branch offset of the branch target address predictor data is determined to be equal to or larger than an offset of a previous target address of another fetch block; and append the mask bit to the associated branch offset of the branch target address predictor data.

In one embodiment, the pipelined processor further includes, in part, a second selection circuit to select from among a multitude of target addresses each associated with a different branch offset of the branch target address predictor data and the fetch block, a target address whose associated mask bit appended branch offset matches the branch offset associated with the determined branch direction. In one embodiment of the pipelined processor, the second selection circuit further selects a default target address for the fetch block if no match is found between the mask bit appended branch offsets and the branch offset associated with the determined branch direction.

In one embodiment, the pipelined processor further includes, in part, a control logic unit to: set a mask bit associated with each branch offset of a branch target address predictor data corresponding to the fetch block to a first logic level; set a mask bit associated with each branch offset of the branch direction predictor data corresponding to the fetch block to the first logic level; and a select logic unit to update a slots selection table with those mask bits of the branch offsets of the branch target address predictor data match the mask bits of the branch direction predictor data.

A non-transitory computer readable medium, in accordance with one embodiment of the present disclosure, includes stored instructions, which when executed by a processor, cause the processor to predict a branch direction of a fetch block. The instructions further causing the processor to determine a multitude of first counts each associated with a different one of a multitude of branch offsets of a branch direction predictor data associated with the fetch block, each of the multitude of first counts representing a number of times that the associated branch offset was taken during a multitude of fetch cycles. The instructions further causing the processor to determine a second count associated with the fetch block, the second count representing a number of times that none of the multitude of branch offsets were taken during the multitude of fetch cycles. The instructions further causing the processor to compute a confidence level based on the multitude of first counts and the second count; and determine the branch direction of the fetch block in accordance with the computed confidence level.

In one embodiment, the instructions further cause the processor to determine the branch direction of the fetch block further in accordance with data representative of a most recently used branch direction. In one embodiment, the instructions further cause the processor to set a mask bit associated with each of the multitude of branch offsets of a branch target address predictor data to a first logic level if the branch offset is determined to be equal to or larger than an offset of a previous target address of another fetch block; and append the mask bit to the associated branch offset of a branch target address predictor data.

In one embodiment, the instructions further cause the processor to select from among a multitude of target addresses each associated with a different branch offset and the fetch block, a target address whose associated mask bit appended branch offset matches the branch offset associated with the determined branch direction.

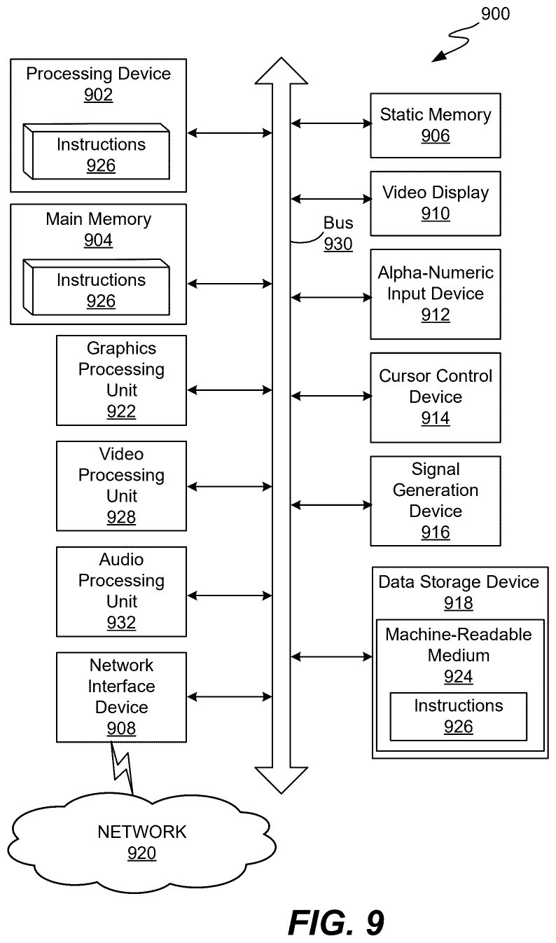

FIG. 9 illustrates an example machine of a computer system 900 within which a set of instructions, for causing the machine to perform any one or more of the methodologies discussed herein, may be executed. In alternative implementations, the machine may be connected (e.g., networked) to other machines in a LAN, an intranet, an extranet, and/or the Internet. The machine may operate in the capacity of a server or a client machine in client-server network environment, as a peer machine in a peer-to-peer (or distributed) network environment, or as a server or a client machine in a cloud computing infrastructure or environment.

The machine may be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 900 includes a processing device 902, a main memory 904 (e.g., read-only memory (ROM), flash memory, dynamic random access memory (DRAM) such as synchronous DRAM (SDRAM), a static memory 906 (e.g., flash memory, static random access memory (SRAM), etc.), and a data storage device 918, which communicate with each other via a bus 930.

Processing device 902 represents one or more processors such as a microprocessor, a central processing unit, or the like. More particularly, the processing device may be complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 902 may also be one or more special-purpose processing devices such as an application specific integrated circuit (ASIC), a field programmable gate array (FPGA), a digital signal processor (DSP), network processor, or the like. The processing device 902 may be configured to execute instructions 926 for performing the operations and steps described herein.

The computer system 900 may further include a network interface device 908 to communicate over the network 920. The computer system 900 also may include a video display unit 910 (e.g., a liquid crystal display (LCD) or a cathode ray tube (CRT)), an alphanumeric input device 912 (e.g., a keyboard), a cursor control device 914 (e.g., a mouse), a graphics processing unit 922, a signal generation device 916 (e.g., a speaker), graphics processing unit 922, video processing unit 928, and audio processing unit 932.

The data storage device 918 may include a machine-readable storage medium 924 (also known as a non-transitory computer-readable medium) on which is stored one or more sets of instructions 926 or software embodying any one or more of the methodologies or functions described herein. The instructions 926 may also reside, completely or at least partially, within the main memory 904 and/or within the processing device 902 during execution thereof by the computer system 900, the main memory 904 and the processing device 902 also constituting machine-readable storage media.

In some implementations, the instructions 926 include instructions to implement functionality corresponding to the present disclosure. While the machine-readable storage medium 924 is shown in an example implementation to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine and the processing device 902 to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm may be a sequence of operations leading to a desired result. The operations are those requiring physical manipulations of physical quantities. Such quantities may take the form of electrical or magnetic signals capable of being stored, combined, compared, and otherwise manipulated. Such signals may be referred to as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the present disclosure, it is appreciated that throughout the description, certain terms refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may include a computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various other systems may be used with programs in accordance with the teachings herein, or it may prove convenient to construct a more specialized apparatus to perform the method. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, and the like.

1. A computer-implemented method of predicting a branch direction of a fetch block in a processor, the computer-implemented method comprising:
determining a plurality of first counts each associated with a different one of a plurality of branch offsets of a branch direction predictor data associated with the fetch block, each of the plurality of first counts representing a number of times that the associated branch offset was taken during a plurality of fetch cycles;
determining a second count associated with the fetch block, the second count representing a number of times that none of the plurality of branch offsets were taken during the plurality of fetch cycles;
computing a confidence level based on the plurality of first counts and the second count; and
determining the branch direction of the fetch block in accordance with the computed confidence level.

2. The computer-implemented method of claim 1, further comprising:
determining the branch direction of the fetch block further in accordance with data representative of a most recently used branch direction.

3. The computer-implemented method of claim 1, further comprising:
setting a mask bit associated with each of a plurality of branch offsets of a branch target address predictor data associated with the fetch block to a first logic level if the branch offset of the branch target address predictor data is determined to be equal to or larger than an offset of a previous target address of the fetch block; and
appending the mask bit to the associated branch offset of the branch target address predictor data.

4. The computer-implemented method of claim 3, further comprising:
selecting, from among a plurality of target addresses each associated with a different branch offset of the branch target address predictor data, a target address whose associated mask bit appended branch offset matches the branch offset associated with the determined branch direction.

5. The computer-implemented method of claim 4, further comprising:
selecting a default target address for the fetch block if no match is found between the mask bit appended branch offsets and the branch offset associated with the determined branch direction.

6. The computer-implemented method of claim 1, further comprising:
updating a filter generator by setting a mask bit associated with each branch offset of a branch target address predictor data corresponding to the fetch block to a first logic level.

7. The computer-implemented method of claim 1, further comprising:
setting a mask bit associated with each branch offset of a branch target address predictor data corresponding to the fetch block to a first logic level;
setting a mask bit associated with each branch offset of the branch direction predictor data corresponding to the fetch block to the first logic level; and
updating a slots selection table if the mask bits of the branch offsets of the branch target address predictor data match the mask bits of the branch direction predictor data.

8. The method of claim 7, further comprising:
combining the fetch block base address with data stored in a prediction history table to generate a first index used to select the branch direction predictor data from at least a first predictor table.

9. The method of claim 8, further comprising:
generating a second index from the fetch block base address to select the branch target address predictor data from at least a second predictor table.

10. The method of claim 8, further comprising:
updating the prediction history table with the determined branch direction.

11. A pipelined processor:
a first counter circuit to determine a plurality of first counts each associated with a different one of a plurality of branch offsets of a branch direction predictor data associated with the fetch block, each of the plurality of first counts representing a number of times that the associated branch offset has been taken during a plurality of fetch cycles;
a second counter circuit to determine a second count associated with the fetch block, the second count representing a number of times that none of the plurality of branch offsets were taken during the plurality of fetch cycles;
a confidence level circuit to compute a confidence level based on the plurality of first counts and the second count; and
a first selection circuit to determine the branch direction of the fetch block in accordance with the computed confidence level.

12. The pipelined processor of claim 11, wherein the selection circuit further determines the branch direction of the fetch block further in accordance with data representative of a most recently used branch direction.

13. The pipelined processor of claim 11, further comprising a comparator circuit to:
set a mask bit associated with each of the plurality of branch offsets of a branch target address predictor data associated with the fetch block to a first logic level if the branch offset of the branch target address predictor data is determined to be equal to or larger than an offset of a previous target address of the fetch block; and
append the mask bit to the associated branch offset of the branch target address predictor data.

14. The pipelined processor of claim 13, further comprising a second selection circuit to:
select, from among a plurality of target addresses each associated with a different branch offset of the branch target address predictor data, a target address whose associated mask bit appended branch offset matches the branch offset associated with the determined branch direction.

15. The pipelined processor of claim 14, wherein the second selection circuit further selects a default target address for the fetch block if no match is found between the mask bit appended branch offsets and the branch offset associated with the determined branch direction.

16. The pipelined processor of claim 11, further comprising:
a control logic unit to:
set a mask bit associated with each branch offset of a branch target address predictor data corresponding to the fetch block to a first logic level;
set a mask bit associated with each branch offset of the branch direction predictor data corresponding to the fetch block to the first logic level; and
a select logic unit to update a slots selection table if the mask bits of the branch offsets of the branch target address predictor data match the mask bits of the branch direction predictor data.

17. A non-transitory computer readable medium comprising stored instructions, which when executed by a processor, cause the processor to predict a branch direction of a fetch block, the instructions further causing the processor to:
determine a plurality of first counts each associated with a different one of a plurality of branch offsets of a branch direction predictor data associated with the fetch block, each of the plurality of first counts representing a number of times that the associated branch offset was taken during a plurality of fetch cycles;
determine a second count associated with the fetch block, the second count representing a number of times that none of the plurality of branch offsets were taken during the plurality of fetch cycles;
compute a confidence level based on the plurality of first counts and the second count; and
determine the branch direction of the fetch block in accordance with the computed confidence level.

18. The non-transitory computer readable medium comprising of claim 17, wherein the instructions further cause the processor to:
determine the branch direction of the fetch block further in accordance with data representative of a most recently used branch direction.

19. The non-transitory computer readable medium comprising of claim 17, wherein the instructions further cause the processor to:
set a mask bit associated with each of the plurality of branch offsets of a branch target address predictor data to a first logic level if the branch offset is determined to be equal to or larger than an offset of a previous target address of the fetch block; and
append the mask bit to the associated branch offset of a branch target address predictor data.

20. The non-transitory computer readable medium comprising of claim 19, wherein the instructions further cause the processor to:
select, from among a plurality of target addresses each associated with a different branch address and the fetch block, a target address whose associated mask bit appended branch offset matches the branch offset associated with the determined branch direction.
